(19) United States
(12) Patent Application Publication
(10) Pub. No.: US 2024/0329289 A1
(43) Pub. Date: Oct. 3, 2024

(54) Surface Mounted Volume Phase Structure and Methods of Manufacturing Thereof

(71) Applicant: DigiLens Inc., Sunnyvale, CA (US)

(72) Inventors: Alastair John Grant, San Jose, CA (US); Milan Momcilo Popovich, Leicester (GB)

(73) Assignee: DigiLens Inc., Sunnyvale, CA (US)

(21) Appl. No.: 18/620,834

(22) Filed: Mar. 28, 2024

Related U.S. Application Data
(60) Provisional application No. 63/492,930, filed on Mar. 29, 2023.

(51) Int. Cl. G02B 5/32; G03H 1/04

(52) U.S. Cl. CPC G02B 5/32; G03H 1/0402; G02B 2207/101; G03H 2001/0439; G03H 2223/25; G03H 2240/11; G03H 2250/32

(57) ABSTRACT

A method for recording a diffractive nanostructure is provided. The method includes: providing a holographic recording mixture including a monomer, an inert material, and a photoinitiator; depositing a layer of the mixture onto a substrate; exposing the mixture to a holographic recording beam to form a nanostructure of polymer regions and inert material regions within the mixture layer; and depositing a surface-conditioning optical layer on top of the nanostructure after curing of the expose mixture.

### CROSS-REFERENCED APPLICATIONS

This application claims priority to U.S. Provisional Application 63/492,930, entitled “Surface Mounted Volume Phased Structure and Methods of Manufacturing Thereof” to Grant et al., filed on Mar. 29, 2023, the disclosure of which is incorporated by reference in its entirety.

### FIELD OF THE INVENTION

The present invention generally relates to surface mounted volume phase structures.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

In some aspects, the techniques described herein relate to a method for recording a diffractive nanostructure, the method including: providing a holographic recording mixture including a monomer, an inert material, and a photoinitiator; depositing a layer of the mixture onto a substrate; exposing the mixture to a holographic recording beam to form a nanostructure of polymer regions and inert material regions within the mixture layer; and depositing a surface-conditioning optical layer on top of the nanostructure after curing of the expose mixture.

In some aspects, the techniques described herein relate to a method, wherein the surface-conditioning optical layer reduces the surface roughness of the nanostructure.

In some aspects, the techniques described herein relate to a method, wherein the surface-conditioning optical layer is a planarization layer.

In some aspects, the techniques described herein relate to a method, wherein the surface-conditioning optical layer includes a refractive index matching the average refractive index of the substrate.

In some aspects, the techniques described herein relate to a method, wherein the surface-conditioning optical layer thickness and/or refractive index are configured for controlling Fresnel reflections and/or polarization rotation of light propagating within the substrate.

In some aspects, the techniques described herein relate to a method, wherein the surface-conditioning optical layer provides a surface for supporting an optical coating.

In some aspects, the techniques described herein relate to a method, wherein the optical coating is an anti-reflection coating.

In some aspects, the techniques described herein relate to a method, wherein the nanostructure is a volume phase structure (VPS).

In some aspects, the techniques described herein relate to a method, wherein the volume phase structure (VPS) is a volume Bragg grating (VBG).

In some aspects, the techniques described herein relate to a method, wherein the inert material is one 1, wherein either the inert material or the polymer is replaced by another material after curing of the nanostructure.

In some aspects, the techniques described herein relate to a method, further including positioning the layer of the mixture between the substrate and a top substrate, and removing the top substrate after exposing the mixture to the holographic recording beam.

In some aspects, the techniques described herein relate to a method, wherein the surface-conditioning optical layer has a bottom surface which conforms to a top surface of the nanostructure and has a planar top surface.

In some aspects, the techniques described herein relate to a diffractive optical device including: a substrate; a diffractive nanostructure supported by a surface of the substrate; and a surface-conditioning optical layer.

In some aspects, the techniques described herein relate to a diffractive optical device, wherein the surface-conditioning optical layer reduces the surface roughness of the diffractive nanostructure.

In some aspects, the techniques described herein relate to a diffractive optical device, wherein the surface-conditioning optical layer is a planarization layer.

In some aspects, the techniques described herein relate to a diffractive optical device, wherein the surface-conditioning optical layer thickness and/or refractive index are configured for controlling Fresnel reflections and/or polarization rotation.

In some aspects, the techniques described herein relate to a diffractive optical device, further including an optical coating on top of the surface-conditioning optical layer.

In some aspects, the techniques described herein relate to a diffractive optical device, wherein the optical coating is an anti-reflection coating.

In some aspects, the techniques described herein relate to a diffractive optical device, configured as a waveguide.

In some aspects, the techniques described herein relate to a diffractive optical device, wherein the nanostructure is a volume phase structure (VPS).

In some aspects, the techniques described herein relate to a diffractive optical device, wherein the VPS is a volume Bragg grating (VBG).

In some aspects, the techniques described herein relate to a diffractive optical device, wherein the nanostructure includes a bias layer.

In some aspects, the techniques described herein relate to a diffractive optical device, wherein the surface-conditioning optical layer has a bottom surface which conforms to a top surface of the nanostructure and has a planar top surface.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 is a flow chart conceptually illustrating a method of fabricating a surface mounted volume periodic structure in accordance with an embodiment of the invention.

FIG. 2 is a flow chart conceptually illustrating a method of fabricating a surface mounted volume periodic structure in accordance with an embodiment of the invention.

FIG. 3 conceptually illustrates a grating structure in accordance with an embodiment of the invention.

FIG. 4 conceptually illustrates a diffractive optical device in accordance with an embodiment of the invention.

FIG. 5 is a schematic of a hybrid grating in accordance with an embodiment of the invention.

FIG. 6 is a schematic of a hybrid grating in accordance with an embodiment of the invention.

### DETAILED DESCRIPTION

The present disclosure relates to volume phase structures (VPS) and more particularly to VPS formed on a substrate surface. The VPS may include a surface-conditioning optical layer deposited on the VPS to reduce surface roughness and the facilitate the use of the VPS on the substrate surface. The surface conditioning optical layer may be a planarization layer. Reducing the surface roughness of the VPS may facilitate the application of an optical layer such as an anti-reflective coating on the VPS which may increase the performance of the VPS. Reducing the surface roughness may also improve the cosmetic appearance of the optical layer, which may be important in near eye waveguide displays.

The manufacturing methods for the diffractive nanostructures share many features with the manufacturing of evacuated periodic structures which are described in U.S. Pat. No. 11,442,222, entitled “Evacuated gratings and methods of manufacturing” and filed Aug. 28, 2020 and U.S. Pat. Pub. No. 2022/0283376, entitled “Evacuated Periodic Structures and Methods of Manufacturing” and filed Mar. 7, 2022, which are hereby incorporated by reference in their entirety.

Various embodiments are directed at methods of forming a VPS on a substrate surface with a surface-conditioning optical layer deposited on the VPS to reduce surface roughness. Many of the nanostructures disclosed may provide gratings for use in waveguides. These waveguides may be utilized in augmented reality (AR) or virtual reality (VR) displays.

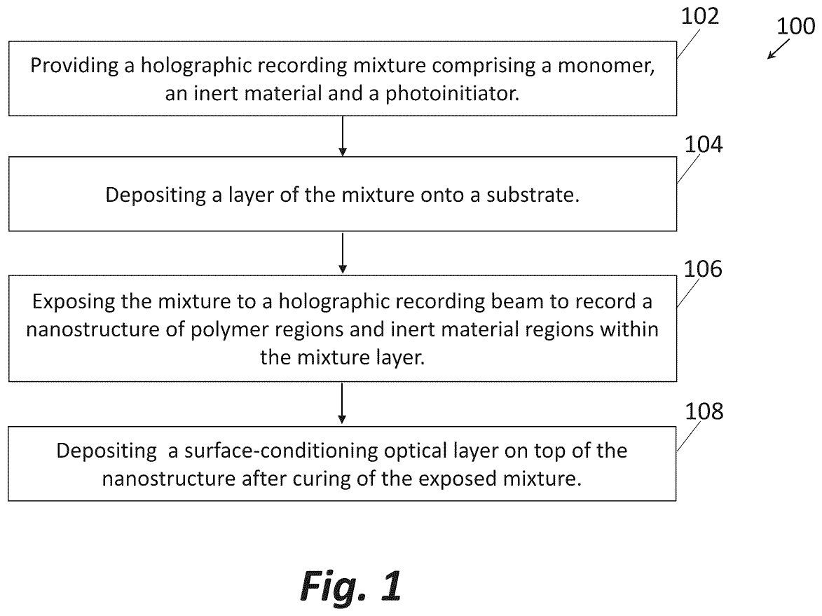

FIG. 1 is a flow chart conceptually illustrating a method of fabricating a surface mounted volume periodic structure in accordance with an embodiment of the invention. The method 100 includes providing (102) a holographic recording mixture comprising a monomer, an inert material and a photoinitiator. The method 100 further includes depositing (104) a layer of the holographic recording mixture onto a bottom substrate. The layer of holographic recoding mixture may be positioned between the bottom substrate and a top substrate.

The method 100 further includes exposing (106) the mixture to a holographic recording beam to record a nanostructure of polymer regions and inert material regions within the mixture layer. The holographic recording beam may be applied through the bottom substrate or the top substrate. Exposing the holographic mixture cures the mixture. Exposing the holographic mixture polymerizes the monomer into polymer rich regions and diffuses the inert material into inert material rich regions. The inert material may be a liquid crystal material. In some cases the inert material may be nanoparticles. In some cases the inert material may be an inert liquid, such as Siloxanes.

After exposure, the top substrate may be removed from the exposed mixture. The method 100 further includes depositing (108) a surface-conditioning optical layer on top of the nanostructure after curing of the exposed mixture. The surface-conditioning optical layer on the VPS may reduce surface roughness. The surface-conditioning layer may act as a planarization layer.

The surface-conditioning layer may have optical properties that facilitate coupling between the VPS and an optical substrate placed on top of it. Examples of these optical properties may include refractive index, thickness, and/or birefringence. For example, the surface-conditioning layer may be used for evanescent coupling to the overlaying substrate (which may be a waveguide).

The substrate supporting the VPS may form part of a waveguide structure or may simply be a transparent element. In some embodiments, the overlaying substrate may be part of a waveguide structure or may be a transparent element. The transparent element may be a plate, prism, lens or some other optical element.

In some embodiments, the VPS couples the waveguide on which it is mounted to a second waveguide. This is a common configuration in optical communications networks.

In some cases, the surface-conditioning layer may modify the surface roughness of the VPS to provide a specified degree of nano-scale surface roughness for use in applications such as surface-enhanced Raman spectroscopy (SERS). Surface roughness of the surface-conditioning layer may be higher than 5 nm. A precision optical coating such as an AR coating may be around 2 nm and a high quality coating may include a roughness of less than around 0.5 nm. Roughness may contribute to poor adhesion of the coating and contribute to haze of a display image.

Surface roughness requirements depend on optical requirement. In some cases the cosmetic quality may be more important particularly in eyeglasses.

Such applications may utilize a gold or silver coating of the surface conditioning layer. In some cases, the VPS may be utilized in optical communications applications, where it may be desirable to eliminate surface roughness to minimize guided signal losses over long distance due to energy being radiated (e.g. scattered) out of the waveguide. The surface-conditioning layer may be used as a refractive index compensation or index matching layer to ensure uniform TIR where the VPS forms part of a waveguide or to provide index continuity with an overlaying substrate.

In some embodiments, the surface-conditioning layer may provide planarization which may provide a surface suitable for thin film coatings other than AR coatings such as color filter, polarization control layers, and/or transparent electrodes. Planarization may also be important in applications where the stacking of multiple substrates, e.g., glass foils, is utilized. In some embodiments, a stack of holographic gratings may be recorded. Planarization may also provide a base for depositing a layer of holographic recording material as part of the recording of the hologram stack.

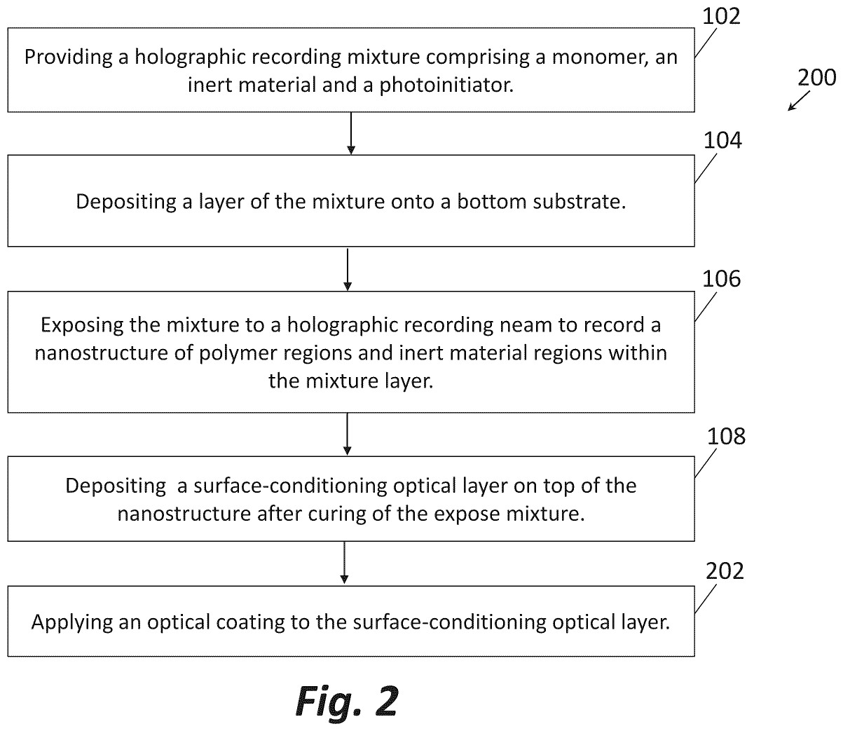

FIG. 2 is a flow chart conceptually illustrating a method of fabricating a surface mounted volume periodic structure in accordance with an embodiment of the invention. The method 200 includes all of the steps described in the method 100 of FIG. 1. Additionally, the method 200 includes applying (202) an optical coating to the surface-conditioning optical layer. The surface-conditioning optical layer may planarize the VPS which may allow for the optical coating to be properly applied to the surface. Without the surface-conditioning optical layer, the optical coating may not function properly. In some embodiments, the optical layer may be an anti-reflective coating.

A surface conditioning layer can be applied using spin coating, spraying or thin film deposition depending on the material and the level of flatness required. The surface conditioning layer may be a high index resin applied using liquid deposition process. Dry deposition (ALD or PECVD) of inorganic material may be used. Silicon and Nitrogen compounds have the advantages of high index, hardness, solvent resistance and high thermal conductivity.

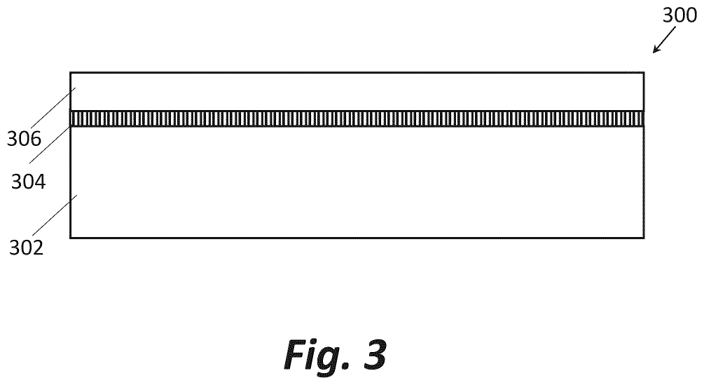

FIG. 3 conceptually illustrates a grating structure in accordance with an embodiment of the invention. The grating structure 300 includes a substrate 302 supporting a diffractive nanostructure 304. The diffractive nanostructure 304 may be a volume phase structure (VPS). When the grating structure 300 is integrated in a waveguide, the VPS may be utilized as an input grating, fold grating, or output grating in an AR or VR display. A surface-conditioning optical layer 306 is positioned over the diffractive nanostructure 304. The grating structure of FIG. 3 may be fabricated utilizing the process described in connection with FIG. 1.

In many embodiments, the surface-conditioning optical layer 306 reduces the surface roughness of the nanostructure. Without limitation to any particular theory, the surface roughness may result from hole formation during photopolymerization and other morphological nonuniformities arising during the phase separation of monomer and inert material. The surface conditioning layer 306 may be used to form a smooth surface that conforms to the average surface of the nanostructure. In many cases, the average surface may be planar. In other cases, the average surface may have an overall curved profile. In some cases, the surface conditioning layer may conform to the surface geometry of the nanostructure. In many embodiments, the surface-conditioning optical layer 306 may be configured as a planarization layer that fills in the surface relief of the nanostructure forming a planar outer surface.

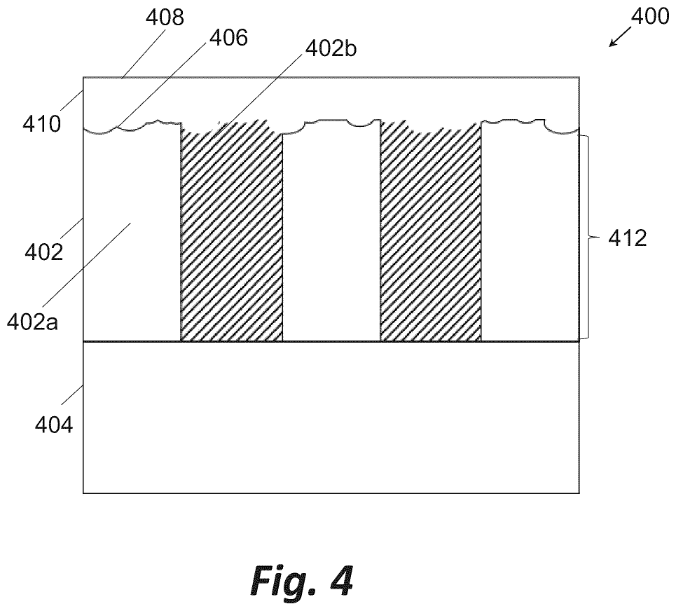

FIG. 4 conceptually illustrates a diffractive optical device in accordance with an embodiment of the invention. The diffractive optical device 400 includes a VPS 402 with alternating polymer rich regions 402a and inert material rich regions 402b. The VPS 402 is positioned on a substrate 404. Typically, holographically recorded grating are fabricated between a top substrate and a bottom substrate. However, the top substrate may add complexity and thickness to the device. It has been discovered that the top substrate may be removed after exposure of the holographic recording material which forms the VPS 402. However, after removal of the top substrate, a top surface 406 of the VPS 402 may including unwanted surface roughness which may degrade performance. As illustrated, the top surface 406 of the VPS 402 may exhibit surface roughness. The VPS 402 includes a bias layer 412 which is the layer between the surface roughness of the top surface 406 and the substrate 404. A planarization layer 410 may be applied to the top surface 406 of the VPS 402. The planarization layer 410 has a lower surface conforming to the geometry of the top surface 406 of the VPS 402 and a planar upper surface 408 which is exposed.

In many embodiments, the planarization layer 410 may be a surface-conditioning optical layer which may be transparent and may have a refractive index matching the average refractive index of substrate 404. In various embodiments, the surface-conditioning optical layer thickness and/or refractive index are configured for controlling Fresnel reflections and or polarization rotation of light propagating within the substrate 404. Configuring the surface-conditioning layer in this way may be useful in waveguide displays, for example for limiting light paths leading to eye glow in waveguided displays and/or minimising illumination non-uniformities.

In many embodiments, an optical coating may be positioned above the surface-conditioning optical layer. The optical coating may be an anti-reflection coating. The decreased surface roughness which is provided by the surface-conditioning optical layer may provide a planar surface which may allow for the optical coating.

The VPS may be a volume Bragg grating (VBG) or a hybrid grating including a surface relief grating (SRG) overlaying a VBG.

The inert material may be a liquid, a liquid crystal, and/or a nanoparticle. In many embodiments, either the inert material or the polymer may be replaced by another material after curing of the nanostructure. In some embodiments, either the inert material or the polymer may be removed to leave a remaining SRG.

It has been discovered that after exposing the holographic material, a hybrid grating may be formed based on the exposure parameters and the composition of holographic recording mixture. The hybrid grating may include an SRG which may overlay a VPS configured as a VBG. The VPS is formed as part of a grating formation process in which the relative thickness of the SRG and VBG are determined by the holographic exposure parameters and the composition of the holographic recording mixture. The surface-conditioning optical layer may planarize the SRG to provide a planar top surface which has superior optical properties.

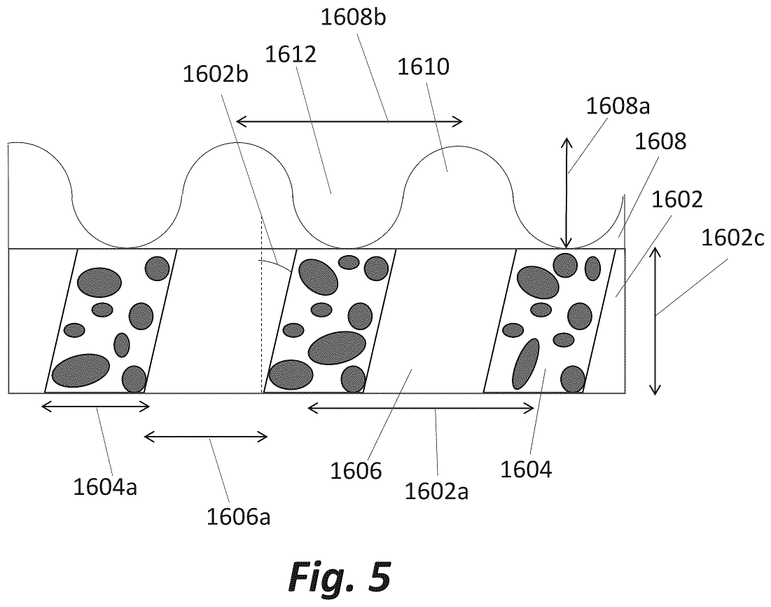

Different exposure conditions have been applied which produce different hybrid gratings. FIG. 5 is a schematic of a hybrid grating in accordance with an embodiment of the invention. The hybrid grating includes a volume phase grating 1602 and a surface relief grating 1608. The volume phase grating 1602 includes alternating polymer rich regions 1606 and inert fluid rich regions 1604. The surface relief grating 1608 includes polymer regions 1610 separated by air regions 1612.

The volume phase grating 1602 includes fringe spacing 1602a which is the spacing between adjacent polymer rich regions 1606. The polymer rich regions 1606 include a width 1606a. The inert fluid rich regions 1604 include a width 1604a. The inert fluid rich regions 1604 may include liquid crystal. The polymer rich regions 1606 may be slanted with a certain slant angle 1602b. The volume phase grating 1602 includes a thickness 1602c.

The surface relief grating 1608 includes fringe spacing 1608b which may be equal to the fringe spacing 1602a of the volume phase grating 1602. The surface relief grating 1608 has a thickness 1608a.

In the case of a dominant surface relief grating, the surface relief grating thickness 1608a may be 20 nm to 100 nm and there may be substantially no volume phase grating thickness 1602c.

In the case of a dominant volume phase grating, the surface relief grating thickness 1608a may be 100 nm to 200 nm and the volume phase grating thickness 1602c may be 200 nm to 500 nm. The ratio of surface relief grating thickness 1608a to volume phase grating thickness 1602c may be about 0.5 to about 1.

In the case of a balanced surface relief grating and volume phase grating, each of the surface relief grating thickness 1608a and the volume phase grating thickness 1602c may be 100 nm to 200 nm.

In some embodiments, the volume phase grating fringe spacing 1602a and the surface relief grating fringe spacing 1608b may be 350 nm to 650 nm. In some embodiments, the duty cycle of the volume phase grating 1602 (inert fluid rich region width 1604a divided by polymer rich region width 1606a) may be 0.5 to 2.0. The volume phase grating slant angle 1602b may be 0 degrees to 20 degrees.

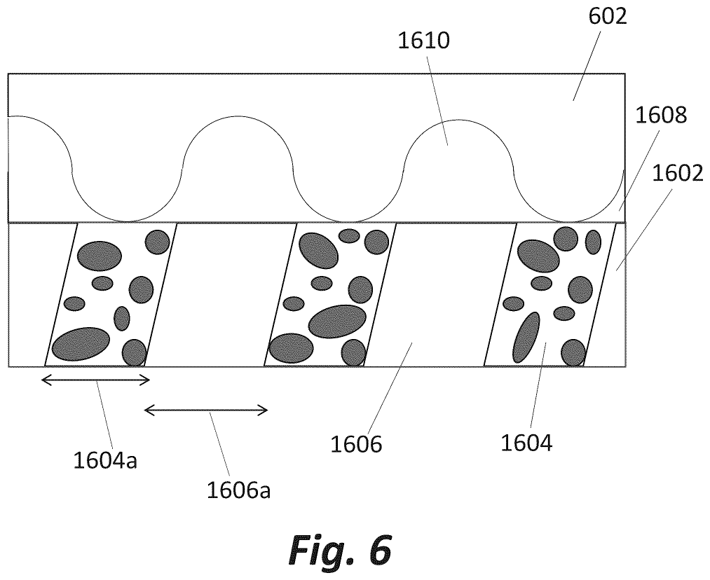

FIG. 6 is a schematic of a hybrid grating in accordance with an embodiment of the invention. The hybrid grating includes many of the identically numbered features of the hybrid grating of FIG. 5. The description of these features are applicable to FIG. 6 and these descriptions will not be repeated in detail. As illustrated, the hybrid grating described in connection with FIG. 5 may be coated with a surface-conditioning layer 602.

The surface-conditioning layer is in direct contact with the polymer regions 1610. The surface-conditioning layer 602 fills in the gaps between the polymer regions 1610 which make up the SRG such that the surface-conditioning layer 602 planarizes the polymer regions 1610.

Although FIG. 6 shows the peaks of the SRG lying in a plane below the top surface of the surface conditioning layer, the peaks of the SRG may, in some cases, lie on the top surface of the surface conditioning layer 602.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for recording a diffractive nanostructure, the method comprising:
providing a holographic recording mixture comprising a monomer, an inert material, and a photoinitiator;
depositing a layer of the holographic recording mixture onto a substrate;
exposing the holographic recording mixture to a holographic recording beam to form a nanostructure of polymer regions and inert material regions within the mixture layer; and
depositing a surface-conditioning optical layer on top of the nanostructure after curing of the exposed mixture.

2. The method of claim 1, wherein the surface-conditioning optical layer reduces a surface roughness of the nanostructure.

3. The method of claim 1, wherein the surface-conditioning optical layer is a planarization layer.

4. The method of claim 1, wherein the surface-conditioning optical layer includes a refractive index matching an average refractive index of the substrate.

5. The method of claim 4, wherein a thickness and/or a refractive index of the surface-conditioning optical layer are configured for controlling Fresnel reflections and/or polarization rotation of light propagating within the substrate.

6. The method of claim 1, wherein the surface-conditioning optical layer provides a surface for supporting an optical coating.

7. The method of claim 6, wherein the optical coating is an anti-reflection coating.

8. The method of claim 1, wherein the nanostructure is a volume phase structure (VPS).

9. The method of claim 8, wherein the volume phase structure (VPS) is a volume Bragg grating (VBG).

10. The method of claim 1, wherein the inert material includes a liquid, a liquid crystal, and/or a nanoparticle.

11. The method of claim 1, wherein either the inert material or the polymer is replaced by another material after curing of the nanostructure.

12. The method of claim 1, further comprising positioning the layer of the mixture between the substrate and a top substrate, and removing the top substrate after exposing the mixture to the holographic recording beam.

13. The method of claim 1, wherein the surface-conditioning optical layer has a bottom surface which conforms to a top surface of the nanostructure and has a planar top surface.

14. A diffractive optical device comprising:
a substrate;
a diffractive nanostructure supported by a surface of the substrate; and
a surface-conditioning optical layer.

15. The diffractive optical device of claim 14, wherein the surface-conditioning optical layer reduces a surface roughness of the diffractive nanostructure.

16. The diffractive optical device of claim 14, wherein the surface-conditioning optical layer is a planarization layer.

17. The diffractive optical device of claim 14, wherein the surface-conditioning optical layer thickness and/or refractive index are configured for controlling Fresnel reflections and/or polarization rotation.

18. The diffractive optical device of claim 14, further comprising an optical coating on top of the surface-conditioning optical layer.

19. The diffractive optical device of claim 18, wherein the optical coating is an anti-reflection coating.

20. The diffractive optical device of claim 14, wherein the substrate is configured as a waveguide.

21. The diffractive optical device of claim 14, wherein the nanostructure is a volume phase structure (VPS).

22. The diffractive optical device of claim 21, wherein the VPS is a volume Bragg grating (VBG).

23. The diffractive optical device of claim 14, wherein the nanostructure includes a bias layer.

24. The diffractive optical device of claim 14, wherein the surface-conditioning optical layer has a bottom surface which conforms to a top surface of the nanostructure and has a planar top surface.
